(19) United States
(12) Patent Application Publication
(10) Pub. No.: US 2026/0240142 A1
(43) Pub. Date: Aug. 20, 2026

(54) CAMOUFLAGED KILLING STATION FOR BURROWING RODENTS

(71) Applicant: Dale E. Shreve, Lompoc, CA (US)

(72) Inventor: Dale E. Shreve, Lompoc, CA (US)

(21) Appl. No.: 19/541,331

(22) Filed: Feb. 16, 2026

Related U.S. Application Data
(60) Provisional application No. 63/758,987, filed on Feb. 14, 2025.

(51) Int. Cl. A01M 23/14; A01M 23/08; A01M 27/00

(52) U.S. Cl. CPC A01M 23/14; A01M 23/08; A01M 27/00

(57) ABSTRACT

A camouflaged pest killing station is disclosed for trapping and dispatching burrowing rodents. The station includes a housing configured to resemble a natural rock or boulder and defining an entrance opening leading to a tunnel. A trap receiving region is positioned in-line along the tunnel so that a target animal encounters a kill trap before reaching an interior bait region. A removable tunnel guide supports staged operation, including a pre-feeding configuration in which the kill trap is removed or disabled to permit bait access and, optionally, the guide is removed, and a trapping configuration in which the guide aligns the animal relative to the kill trap. The station may include an open-bottom tunnel portion permitting native soil within the tunnel, an awning guard, bait storage, and anchoring or safety features. In some embodiments, the station receives an automatic-reset kill trap.

### CROSS-REFERENCE TO RELATED APPLICATIONS

This application claims the benefit of U.S. Provisional Patent Application No. 63/758,987, filed February 14, 2025, titled “TERRATRAP GS,” the entire disclosure of which is incorporated by reference herein.

### STATEMENT REGARDING FEDERALLY SPONSORED RESEARCH OR DEVELOPMENT

Not applicable.

### REFERENCE TO A SEQUENCE LISTING

Not applicable.

### FIELD OF THE INVENTION

The present disclosure relates to pest control devices and methods, and more particularly to camouflaged trapping and killing stations for burrowing rodents such as ground squirrels.

### BACKGROUND

Ground squirrels and other burrowing rodents can cause substantial damage to crops, landscaping, irrigation lines, earthen berms, and related infrastructure. In addition to direct feeding and burrowing damage, rodent activity may create hazards for equipment, livestock, and people.

Historically, rodent control has relied heavily on poisons and bait toxicants. In many jurisdictions, however, the availability and use of certain rodenticides has been limited or prohibited, increasing demand for effective physical trapping solutions.

Conventional traps and bait stations are often labor intensive to deploy and service, may be conspicuous in the environment, and can present unwanted risk to non-target animals, children, and pets. Conventional trap configurations may also be less effective when target animals avoid unfamiliar structures, open floors, or non-burrow-like travelways.

Burrowing rodents commonly prefer enclosed travelways and soil contact that resemble natural burrow conditions. A need exists for a trapping station that blends into the environment, mimics preferred burrow characteristics, promotes rapid acclimation and entry by target animals, and supports safe, efficient service with reduced human intervention.

### SUMMARY

A camouflaged killing station is disclosed that resembles a natural rock or boulder and defines an entrance tunnel leading in-line to a kill trap position. The in-line arrangement places a kill trap along a tunnel axis between an entrance opening and an interior bait region, such that a target animal encounters the kill trap before reaching bait stored within the station.

In exemplary embodiments, a removable tunnel guide is selectively installed within the tunnel. When installed, the guide forms a guide passage that aligns a target animal relative to the kill trap and may assist with installation, removal, and servicing of the kill trap. When the kill trap is absent or otherwise disabled, the station may be operated in a pre-feeding configuration in which target animals can enter and access bait to acclimate to the station. In some embodiments, the removable tunnel guide may also be removed during pre-feeding to provide a larger or less restrictive tunnel profile.

In exemplary embodiments, at least a portion of the tunnel is open-bottomed so that native soil may remain within the tunnel when the station is placed on the ground, further mimicking natural burrow conditions. The station may include an awning guard above the entrance opening, a removable cover for service access, a bait tray or bait storage cavity, anchoring features such as stake apertures, and safety features that reduce access by non-target animals, children, and pets.

The station may be configured to receive an automatically resetting kill trap (for example, a CO2-powered impact trap) to reduce servicing frequency. In certain deployments, a dispatched animal may be accessible through the entrance opening to permit removal by scavenger animals, thereby reducing human handling and facilitating repeated trapping cycles.

Additional features and advantages will be apparent from the following description and the accompanying drawings.

### BRIEF DESCRIPTION OF THE DRAWINGS

FIG. 1 is a front perspective view of an exemplary pest killing station resembling a natural boulder, showing an entrance opening and an awning guard.

FIG. 2 is an exploded perspective view of the station of FIG. 1, illustrating a removable cover, a base, an entrance module, a removable tunnel guide, a trap mount region, and a bait tray.

FIG. 3 is a longitudinal cross-sectional view taken generally along a tunnel axis, illustrating an open-bottom tunnel portion, an installed removable tunnel guide forming a guide passage, a trap receiving region with a trap mount and a kill trap, and an interior bait storage region.

FIG. 4 is a longitudinal cross-sectional view illustrating an exemplary pre-feeding configuration in which a kill trap is removed or otherwise disabled to permit access to bait, and in which the removable tunnel guide is shown removed from the tunnel (and may optionally be installed during pre-feeding in certain operating protocols).

FIG. 5 is a top perspective view illustrating service access with the removable cover removed, showing an exemplary bait tray and a trap mount.

FIG. 6 is a side elevation view illustrating an anchoring arrangement in which the station is secured to the ground with stakes and includes an optional ballast cavity.

FIG. 7 is a perspective view of an alternative embodiment having multiple entrance openings and multiple entrance tunnels leading toward an interior region of the station.

FIG. 8 is a cutaway perspective view of an alternative embodiment including internal baffles forming a tortuous path to increase resistance to access by children, pets, and non-target animals.

### DETAILED DESCRIPTION

The following description is presented to enable a person of ordinary skill in the art to make and use the disclosed subject matter and to describe various embodiments and best modes presently contemplated. The described embodiments are not intended to be exhaustive or limiting. Rather, the scope of the invention is defined by the claims and equivalents thereof.

For purposes of illustration, certain components are shown schematically and are not necessarily drawn to scale. Like reference numerals refer to like features throughout the drawings.

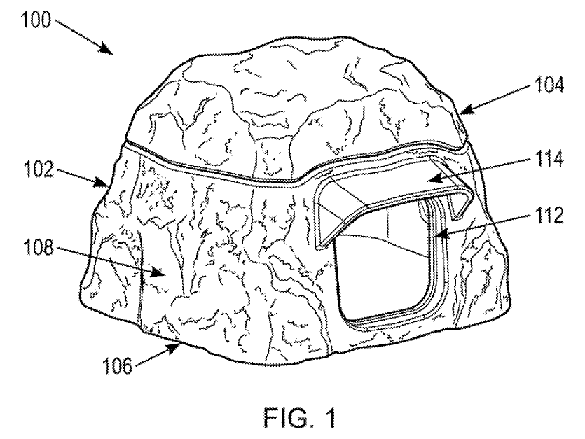

Referring to FIGS. 1-6, an exemplary pest killing station 100 includes an exterior housing 102 having an exterior surface 108 configured to resemble a natural rock or boulder when deployed outdoors. In the illustrated embodiment, the housing 102 includes a removable cover 104 and a base 106 that cooperatively define an interior region.

The cover 104 may provide a boulder-like appearance, while the base 106 may provide a stable ground interface. In some embodiments, the base 106 includes a generally planar lower surface, feet, or ribs that contact the ground and define one or more recesses that can accept soil and debris without interfering with operation.

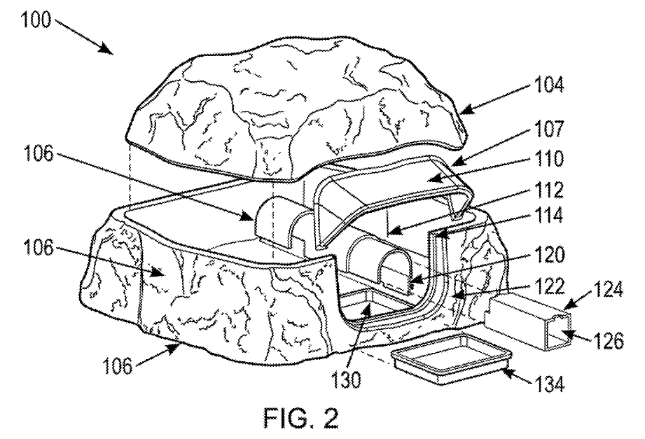

An entrance opening 112 is formed in a front portion of the housing 102. In the illustrated embodiment, the entrance opening 112 is defined by an entrance module 107 (FIG. 2) that is coupled to the housing 102. The entrance module 107 may be removable to facilitate cleaning, servicing, replacement, or adaptation to different target species.

An awning guard 114 may overhang the entrance opening 112. The awning guard 114 may reduce visibility of the opening from above, reduce entry by non-target animals (for example, small birds), and reduce exposure of the entrance to precipitation and wind-blown debris. In some embodiments, the awning guard 114 is integrally formed with the entrance module 107; in other embodiments, the awning guard 114 is a separate component.

A tunnel 110 extends inward from the entrance opening 112 generally along a tunnel axis 116. The tunnel 110 may be circular, oval, rectangular, or otherwise shaped. In certain embodiments, the tunnel 110 is sized to favor entry by a target animal while discouraging entry by non-target animals.

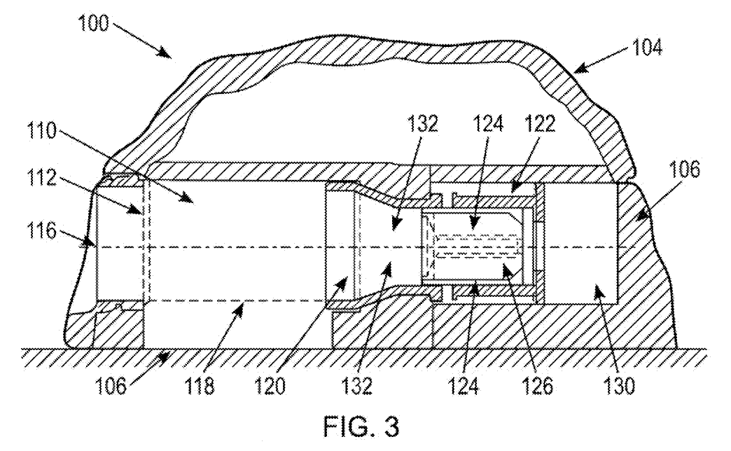

In the illustrated embodiments, at least a portion of the tunnel 110 is configured to mimic burrow characteristics preferred by burrowing rodents. For example, as shown in FIG. 3, an open-bottom tunnel portion 118 permits native soil to occupy part of the tunnel 110 when the station 100 is placed on the ground, thereby providing soil contact, scent, and texture similar to a natural burrow.

The open-bottom tunnel portion 118 may be provided by an absence of a floor wall over a defined length of the tunnel 110. In other embodiments, a floor panel (not shown) may be removably installed to close the bottom of the tunnel for certain placement conditions (for example, placement on hard surfaces) and removed for placement on soil.

A trap receiving region 122 is positioned in-line along the tunnel axis 116 between the entrance opening 112 and an interior bait storage region 130. In certain embodiments, the trap receiving region 122 includes a trap mount 126 configured to position a kill trap 124 in a repeatable, stable orientation relative to the tunnel axis 116.

The trap mount 126 may include a keyed interface that constrains rotational orientation of the kill trap 124, a stop surface that fixes longitudinal position, and/or one or more retention features such as latches, clips, straps, or fasteners. The trap mount 126 may be configured so that, when the kill trap 124 is installed and armed, the kill trap 124 presents an active kill mechanism along the tunnel axis 116.

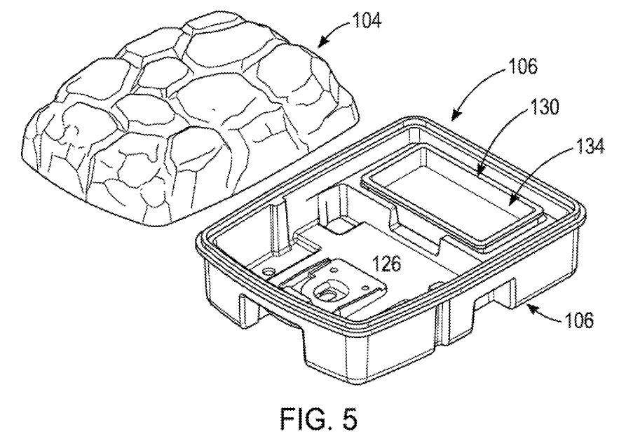

The bait storage region 130 may be sized to hold a substantial quantity of bait to reduce servicing frequency. In one example, the bait storage region 130 is configured to hold up to approximately two pounds of dry bait such as raw peanuts or grain. The bait may be contained within a removable bait tray 134 (FIGS. 2 and 5) or may be stored directly in an interior cavity. The bait storage region 130 is preferably accessible when the cover 104 is removed for servicing (FIG. 5).

In some embodiments, bait may also be placed within the tunnel 110 or proximate the entrance opening 112 during an acclimation period to encourage initial entry. Bait placement and type may be selected based on target species behavior and local environmental conditions.

A removable tunnel guide 120 may be selectively installed within the tunnel 110. When installed (FIG. 3), the removable tunnel guide 120 defines a guide passage 132 that constrains or aligns a target animal traveling through the tunnel 110 so that the animal is presented to the kill trap 124 in a desired position.

The removable tunnel guide 120 may also serve as a service feature by facilitating insertion and removal of the kill trap 124, reducing unwanted debris accumulation near the trap receiving region 122, and/or improving repeatable positioning of the kill trap 124 relative to the tunnel axis 116. In one implementation, the removable tunnel guide 120 is a sleeve, cartridge, or insert that is removable without tools.

The removable tunnel guide 120 may include an alignment feature that mates with a corresponding feature of the housing 102 (for example, a shoulder, notch, detent, or keyed geometry) to establish a repeatable installed position relative to the trap receiving region 122.

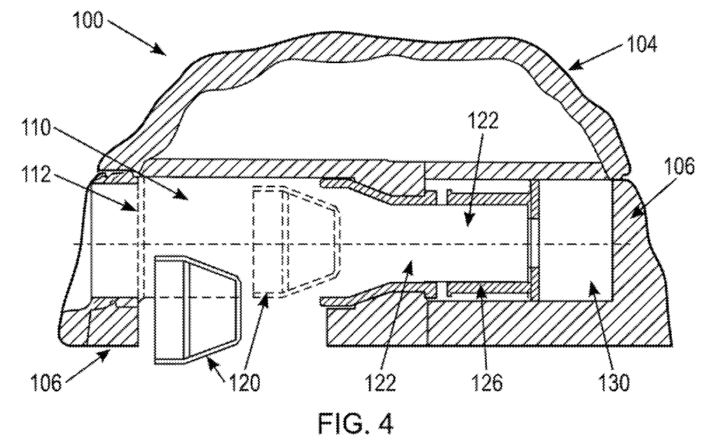

The station 100 may be operated in at least two modes. In a trapping configuration, the removable tunnel guide 120 is installed and the kill trap 124 is installed at the trap receiving region 122 (FIG. 3). In a pre-feeding configuration, the kill trap 124 is absent from the trap receiving region 122 or otherwise disabled to prevent lethal operation and permit bait access. In certain implementations, the removable tunnel guide 120 is also removed during pre-feeding (FIG. 4), thereby providing a larger or less restrictive travelway and an unobstructed path from the entrance opening 112 through the tunnel 110 to the bait storage region 130. The pre-feeding configuration permits target animals to enter, feed, and become accustomed to the station 100, which may increase subsequent capture success after the station is transitioned to the trapping configuration.

After an acclimation period, the station 100 may be transitioned to the trapping configuration by installing and arming the kill trap 124 at the trap receiving region 122 and, when used, reinstalling the removable tunnel guide 120. Pre-feeding protocols may be tailored to local conditions and target species behavior. For example, in some deployments pre-feeding may be performed with the removable tunnel guide 120 installed, while the kill trap 124 is removed or disabled, and in other deployments both the kill trap 124 and the removable tunnel guide 120 are removed during pre-feeding.

The kill trap 124 may be any suitable lethal trap mechanism configured to dispatch a burrowing rodent upon entry into the tunnel 110. In some embodiments, the kill trap 124 is a mechanically resetting trap. In other embodiments, the kill trap 124 is an automatically resetting trap. An example of an automatically resetting trap is a CO2-powered impact trap, although other trap types may be used.

In certain embodiments, the station 100 is configured so that a dispatched animal is accessible from outside the housing 102 through at least one opening, such as the entrance opening 112, to permit removal by scavenger animals. In deployments using an automatically resetting kill trap, this access may reduce human handling and may allow repeated trapping cycles with reduced servicing frequency.

In other embodiments, the station 100 may include an internal retention feature (not shown) configured to retain dispatched animals within the housing 102 until removed by an operator. In still other embodiments, a removable container or tray (not shown) may be provided to facilitate hygienic disposal.

The kill trap 124 may be arranged so that a target animal is dispatched at or near the trap receiving region 122. In some embodiments, the in-line placement of the trap receiving region 122 functions as a gate that blocks access to the interior bait storage region 130 when the kill trap 124 is armed, thereby discouraging bait depletion without capture.

Service access may be provided by removing the cover 104 from the base 106 (FIG. 5). The cover 104 and base 106 may be removably coupled by any suitable interface, including mating flanges, friction fits, latches, clips, fasteners, or combinations thereof. In some embodiments, the interface provides resistance to opening by children and pets while still allowing convenient access by an authorized user.

With the cover 104 removed, an operator may replenish bait in the bait storage region 130, remove and service the kill trap 124 at the trap mount 126, and remove debris. In certain embodiments, the entrance module 107 is removable and may be replaced or serviced independently from the cover 104 and base 106.

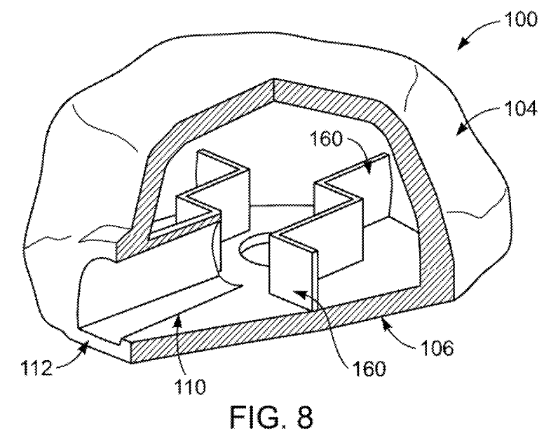

The station 100 may incorporate one or more child- and pet-resistance features, including reduced entrance opening size, internal baffles, tortuous paths, shields that limit line-of-reach access, and/or lockable service interfaces. FIG. 8 illustrates one example in which internal baffles 160 provide a tortuous path to the interior region while still permitting access by a target animal.

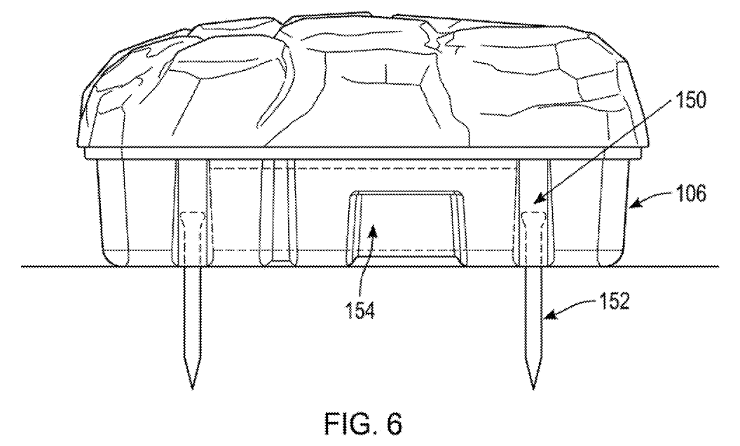

As shown in FIG. 6, the station 100 may include one or more anchoring features such as stake apertures 150 configured to receive stakes 152. Anchoring reduces the likelihood that the station 100 is displaced by target animals, scavengers, pets, livestock, wind, or water flow. In addition or alternatively, the base 106 may include a ballast cavity 154 that can be filled with soil, rocks, or other ballast to increase stability.

In some deployments, anchoring features may include chain or cable attachment points, ground spikes, or integrated ground-contact features on the base 106. The particular anchoring approach may be selected based on terrain, weather exposure, and target species behavior.

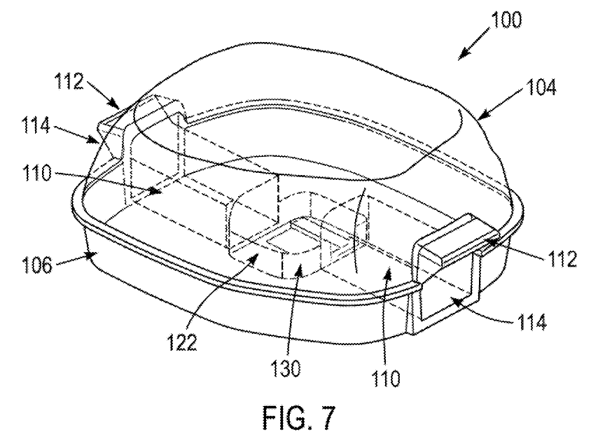

Referring to FIG. 7, in an alternative embodiment the station 100 includes multiple entrance openings 112 and multiple corresponding tunnels 110 leading toward a common interior region. Multiple entrances may increase encounter rates by providing multiple approach paths, including approach paths aligned with existing burrow routes or traffic patterns.

The housing 102 may be formed from any suitable material, including molded polymer, reinforced polymer composites, fiberglass, cementitious materials, or combinations thereof. Exterior texturing and coloration may be selected to resemble local rock formations. Interior surfaces may be formed to facilitate cleaning and to resist environmental degradation.

Although certain embodiments have been described with reference to ground squirrels, the station 100 may be configured for other target animals including other burrowing rodents, with tunnel dimensions, bait selection, and trap selection adapted accordingly.

### INTERPRETATION

As used herein, the terms “including,” “comprising,” and “having” are to be interpreted as open-ended, and do not exclude additional elements or steps. Unless the context dictates otherwise, the singular includes the plural and the plural includes the singular.

No element, component, or method step is intended to be dedicated to the public regardless of whether the element, component, or method step is explicitly recited in the claims. No claim element herein is to be construed under 35 U.S.C. 112(f) unless the element is expressly recited using the phrase “means for,” and no method step is to be construed under 35 U.S.C. 112(f) unless expressly recited using the phrase “step for.”

What is claimed is:

1. A pest killing station comprising:
a housing having an exterior surface configured to simulate a natural rock when placed in an outdoor environment;
an entrance opening formed in the housing;
a tunnel extending from the entrance opening along a tunnel axis;
a trap receiving region disposed in-line along the tunnel axis between the entrance opening and an interior region of the housing, the trap receiving region being configured to receive a kill trap;
a bait storage region within the interior region of the housing, the bait storage region being configured to hold bait for attracting a target animal; and
a removable tunnel guide selectively positionable within the tunnel;
wherein, in a trapping configuration with the removable tunnel guide installed and a kill trap installed at the trap receiving region, the removable tunnel guide defines a guide passage that aligns the target animal relative to the kill trap; and
wherein, in a pre-feeding configuration with at least the removable tunnel guide removed and the kill trap absent from the trap receiving region, the tunnel provides access for the target animal to enter the interior region of the housing and consume the bait.

2. The pest killing station of claim 1, wherein the tunnel includes an open-bottom portion configured to allow native soil to occupy at least part of the tunnel when the station is placed on the ground.

3. The pest killing station of claim 2, wherein the open-bottom portion extends from the entrance opening to a location proximate the removable tunnel guide.

4. The pest killing station of claim 1, wherein the bait storage region is configured to store up to approximately two pounds of dry bait.

5. The pest killing station of claim 1, wherein the housing comprises a base and a removable cover, and wherein removal of the cover provides service access to the trap receiving region and the bait storage region.

6. The pest killing station of claim 1, further comprising an awning guard positioned above the entrance opening and configured to reduce direct visibility into the tunnel from above.

7. The pest killing station of claim 1, further comprising at least one anchoring feature selected from the group consisting of a stake aperture, a ground spike interface, a chain attachment, and a ballast cavity.

8. The pest killing station of claim 1, wherein the trap receiving region comprises a trap mount having a keyed interface that receives and positions the kill trap in a repeatable orientation relative to the tunnel axis.

9. The pest killing station of claim 8, wherein the trap mount is configured to receive an automatic-reset kill trap.

10. The pest killing station of claim 9, wherein the trap mount is configured to receive a CO2-powered impact trap.

11. The pest killing station of claim 1, wherein the station is configured such that, after dispatch of the target animal by a kill trap installed at the trap receiving region, the dispatched animal is accessible from outside the housing through at least one opening to permit removal by scavenger animals.

12. The pest killing station of claim 11, wherein the at least one opening is the entrance opening.

13. The pest killing station of claim 1, wherein the station is configured to be child- and pet-resistant by at least one of: reduced entrance opening size, an internal baffle, a tortuous path, and a lockable service interface.

14. The pest killing station of claim 1, wherein the removable tunnel guide comprises a sleeve insert that is removable without tools.

15. The pest killing station of claim 1, wherein the removable tunnel guide includes an alignment feature that mates with a corresponding feature of the housing to establish a repeatable installed position.

16. A kit comprising:
the pest killing station of claim 1; and
a kill trap configured to be mounted at the trap receiving region.

17. The kit of claim 16, wherein the kill trap is an automatic-reset kill trap.

18. A method of trapping a ground squirrel or other burrowing rodent using a camouflaged station, the method comprising:
placing the pest killing station of claim 1 at an outdoor location;
loading bait into the bait storage region;
operating the pest killing station in the pre-feeding configuration for an acclimation period by removing at least the removable tunnel guide and ensuring that the trap receiving region is free of an armed kill trap;
after the acclimation period, installing the kill trap at the trap receiving region and installing the removable tunnel guide to place the station in the trapping configuration; and
allowing the target animal to enter the entrance opening and encounter the kill trap in-line within the tunnel.

19. The method of claim 18, further comprising anchoring the station to the ground with at least one stake.

20. The method of claim 18, wherein the tunnel includes an open-bottom portion and the method further comprises placing the station on soil such that native soil occupies at least part of the tunnel.
